(19) United States
(12) Patent Application Publication
(10) Pub. No.: US 2024/0303592 A1
(43) Pub. Date: Sep. 12, 2024

(54) LOGISTICS WAREHOUSE OPERATING SYSTEM FOR BUYER

(71) Applicants: Zhen-sheng Wang, SANTA FE SPRINGS, CA (US); Ze-Nong Wang, SANTA FE SPRINGS, CA (US); Ze-Feng Wang, SANTA FE SPRINGS, CA (US)

(72) Inventors: Zhen-sheng Wang, SANTA FE SPRINGS, CA (US); Ze-Nong Wang, SANTA FE SPRINGS, CA (US); Ze-Feng Wang, SANTA FE SPRINGS, CA (US)

(21) Appl. No.: 18/118,724

(22) Filed: Mar. 7, 2023

(51) Int. Cl. G06Q 10/087; G06Q 30/0601

(52) U.S. Cl. CPC G06Q 10/087; G06Q 30/0635

(57) ABSTRACT

A logistics warehouse operating system applied to a buyer is provided. The system is set up in a server and includes an order placing module, a work order module, an incoming stock module, and an outgoing stock module. Through the system, the buyer can quickly create orders and accurately input its own needs in each module, so that the seller can process them quickly and accurately respond and process the order from the buyer.

### BACKGROUND OF THE INVENTION

### 1. Field of the Invention

The present disclosure relates to a logistics warehouse operating system for a buyer, and more particularly to the technology applied in the field of logistics management. Specifically, the logistics warehouse operating system of the present disclosure allows the buyer to provide and input detailed information to the seller according to their own needs, and also convenient for the seller to operate clearly and quickly.

### 2. Descriptions of Related Art

With the development of science and technology, the Internet has greatly shortened the distance between people, and even the distance between countries. Through the Internet, products can be purchased from various countries, which also promotes the development of international trade.

Generally, when customers (hereinafter, “buyer”) need to purchase products from manufacturers and suppliers, they will use the simple web form built by the manufacturer or supplier (hereinafter, “seller”) to select the products and place the order. Most of them also communicate by means of sending e-mails, telephone calls, and text messages.

However, the simple website form built by the seller cannot satisfy all different types of buyers. Further, when the buyer suddenly needs to add, change, or delete an order, or when the buyer has other requirements or restrictions, communication through email, phone call, and text message may cause unnecessary trouble. Moreover, it is also very time-consuming and labor-intensive for the seller.

### SUMMARY OF THE INVENTION

The present provides a system that the buyer can accurately input the information in need in placing a new order, adding more products, reducing products, canceling the order, as well as other requirements, restrictions, etc. The system allows the seller to quickly produce the order, smoothly carry out the internal process of the seller, and the products can be shipped to the buyer quickly. The system of the present disclosure not only reduces time consumption, but also improves the deficiencies that the data transmission between the buyer and the seller is too slow, or the delay time caused by lack of information from the buyer.

In order to achieve the object and the advantage mentioned above, the present disclosure provides a logistics warehouse operating system, applied to a buyer and set up in a server, including: an order placing module, including a basic information unit and an inquiry unit; wherein the buyer fills in the recipient's information, address, and products in the basic information unit; the inquiry unit includes a fee list showing the fee according to different destinations; wherein the order placing module further generates an order; a work order module, connected with the order placing module, the order is transmitted to the work order module, and the work order module generates a work order by the information of the order; wherein the work order includes a work order type unit, a work order level unit and a business selecting unit; wherein the work order type unit lists the operation mode for the goods, the work order level unit lists the processing speed of the goods, and the business selecting unit lists the number of the goods to be processed for the buyer to select;
an incoming stock module, receiving the order and work order and generating an incoming stock list; wherein the incoming stock list includes an incoming stock information unit and an incoming goods list unit, the incoming stock information unit has incoming stock information, and the incoming goods list unit is used for the buyer to fill in the processing method after incoming stock information is completed; and an outgoing stock module, receiving the order and work order and generating an outgoing stock list; wherein the outgoing stock list includes a shipment information unit and an outgoing goods list unit, the shipment information unit is used to choose the shipment type and to generate a shipment processing list, and the outgoing goods list unit is used to choose the shipment type.

Accordingly, the system allows the buyer to quickly create orders and allows the seller to process them quickly. Specifically, the buyer can accurately input its own needs in each module, so that the seller can accurately respond to and process the order from the buyer.

### BRIEF DESCRIPTION OF THE DRAWINGS

The described embodiments may be better understood by reference to the following description and the accompanying drawings in which:

FIG. 1 is a block schematic diagram of the present disclosure.

FIG. 2 is a block schematic diagram of the order placing module of the present disclosure.

FIG. 3 is a block schematic diagram of the work order module of the the present disclosure.

FIG. 4 is a block schematic diagram of the incoming stock module of the present disclosure.

FIG. 5 is a block schematic diagram of the outgoing stock module of the present disclosure.

FIG. 6 is a block schematic diagram of the return module of the present disclosure.

### DETAILED DESCRIPTION OF THE PREFERRED EMBODIMENTS

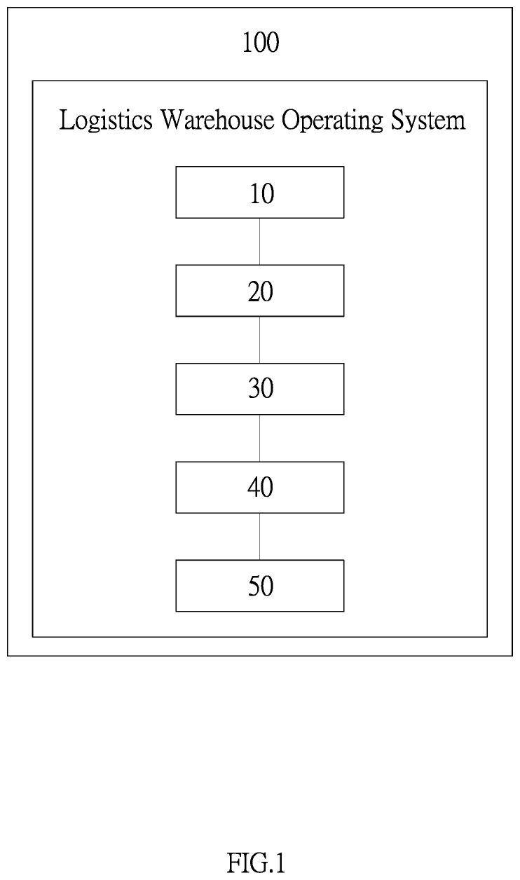

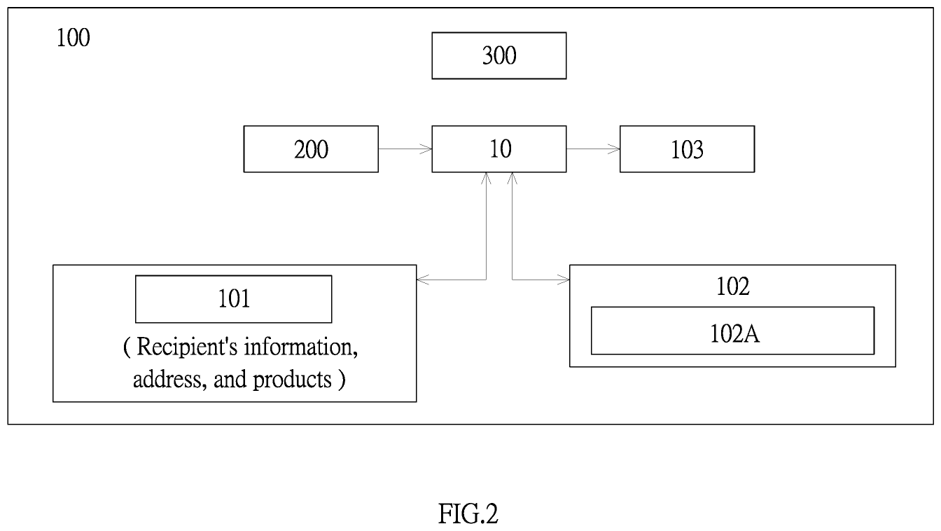

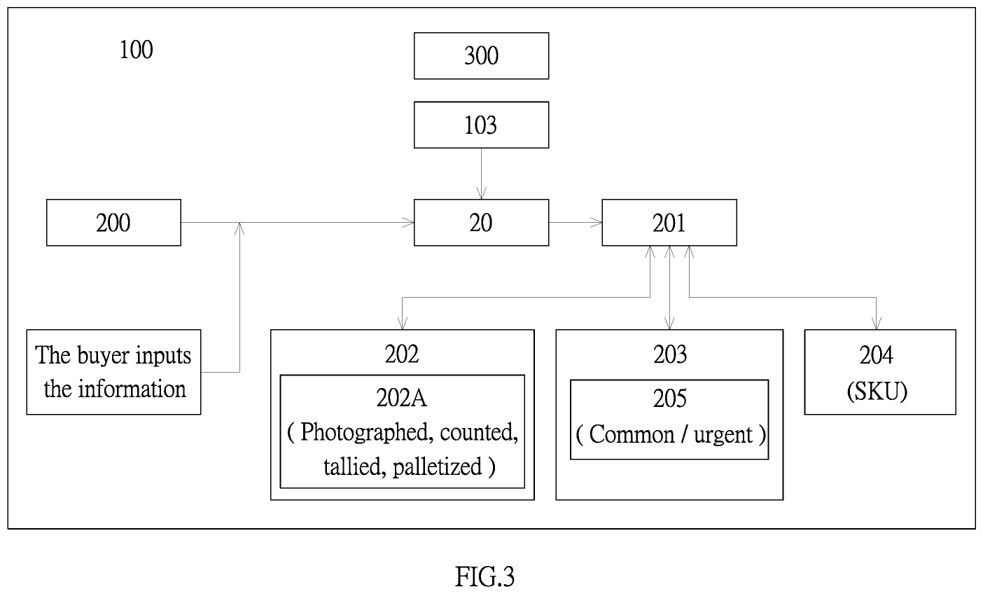

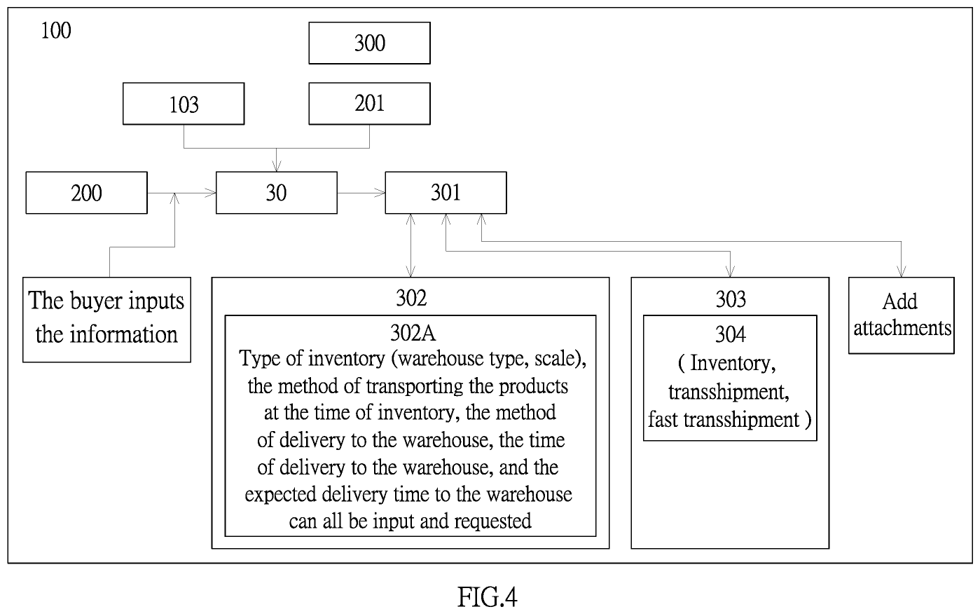

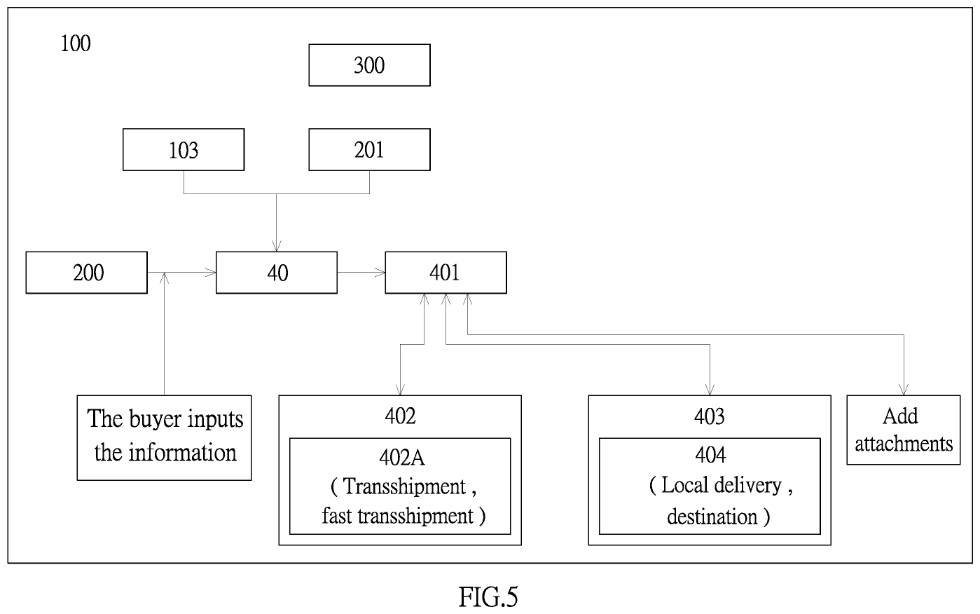

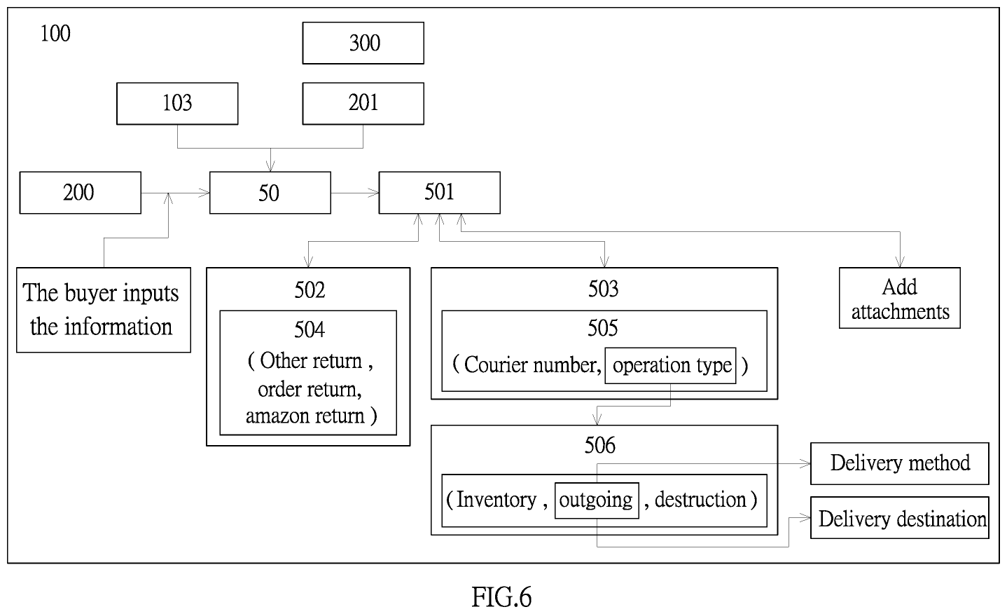

Referring to FIGS. 1-6, the present disclosure provides a logistics warehouse operating system, applied to a buyer and set up in a server 100. The logistics warehouse operating system includes an order placing module 10, a work order module 20, an incoming stock module 30, and an outgoing stock module 40. The order placing module 10 is used to apply for the buyer 200 to fill in the basic information. The order placing module 10 includes a basic information unit 101 and an inquiry unit 102. The buyer 200 fills in the recipient's information, address, and products in the basic information unit 101. The inquiry unit 102 includes a fee list 102A showing the fee according to different destinations. The buyer 200 can select the cost according to the destination. After filling the order placing module 10, a purchase order 103 is further generated. The work order module 20 is used to allow the buyer 200 to choose the processing method for the goods. The work order module 20 is connected with the order placing module 10. After the purchase order 103 is transmitted to the work order module, and the work order module 20 generates a work order 201 by the information of the purchase order 103. The work order 201 includes a work order type unit 202, a work order level unit 203 and a business selecting unit 204. The work order type unit 202 lists the operation mode for the goods and generates a type information input 202A, the work order level unit 203 lists the processing speed of the goods, and the business selecting unit 204 lists the number of the goods to be processed for the buyer 200 to select.

The incoming stock module 30 is used to preliminary process the products when the products arrive the seller 300 according to the requirement of the buyer 200. The incoming stock module 30 receives the purchase order 103 and work order 201 and generating an incoming stock list 301. The incoming stock list 301 is generated by the information input by the buyer 200 includes an incoming stock information unit 302 and an incoming goods list unit 303, the incoming stock information units 302 shows and generates an incoming stock information list 302A, and the incoming goods list unit 303 is used for the buyer 200 to fill in the processing method after incoming stock information unit 302 is completed. The outgoing stock module 40 is used for the buyer 200 to fill in the requirements and restrictions of shipping. The outgoing stock module 40 receives the purchase order 103 and work order 201 and generates an outgoing stock list 401. The outgoing stock list 401 includes a shipment information unit 402 and an outgoing goods list unit 403, the shipment information unit 402 is used to choose the shipment type and generate a shipment processing list 402A, and the outgoing goods list unit 403 is used to choose the shipment way.

According to the description, the buyer 200 can input the information through the system provided by the seller 300. More specifically, all information about the recipient (name, business name, phone number, region (east coast/west coast), address, etc.) can be input by the basic information unit 101 of the order placing module 10. The buyer 200 can also use the menu list 102A in the inquiry unit 102 to check the suitable price for different locations, operation methods, and delivery methods. The purchase order 103 can be generated after the confirmation.

The seller 300 can purchase the products according to the purchase order 103 from the buyer 200, and the buyer 200 can keep entering the information in the work order module 20. In other words, the buyer 200 can select the process method for the products in the work order type unit 202. For example, after the products arrive and have not been incoming into the warehouse, the products can be first photographed, counted, tallied, palletized (a labor process in which products are put onto pallets and then wrapped with packing tape) and labeled. Further, the work order level unit 203 includes a level list 205, the level list 205 is used for the buyer 200 to choose a common option or an urgent option to process the products, so that the products can be effectively processed with different levels of demand quickly.

The buyer 200 can continue to input the information to the incoming stock module 30, and can select the inventory method for the products. In simple terms, the buyer 200 can choose the type of inventory (warehouse type, scale), the method of transporting the products at the time of inventory, the method of delivery to the warehouse, the time of delivery to the warehouse, and the expected delivery time to the warehouse can all be input and requested. In addition, the buyer 200 can also leave a note or a message for the relevant party.

Further, the buyer 200 can also decide the process to the products. The incoming goods list unit further provides an incoming processing list 304 having input fields for inventory, transshipment with label replacement, and fast transshipment. The buyer 200 can choose the following processing method for the products, so as to shorten the time that the products stay in the same warehouse. If the products stay in the original warehouse, “inventory” is selected. If the products transfer to another warehouse, “transshipment with label replacement” is selected. If the products are urgent to transfer, “fast transshipment” is selected. Therefore, the occupancy time of products in the warehouse can be shortened.

Referring to the processing of the shipment, the buyer 200 can select the processing method of shipment. The buyer 200 can input the information about the shipment way, and products to be shipped in the shipment information unit 402 of the outgoing stock module 40. In other words, the buyer 200 can select a clear handling method for products and the location to deliver, such as transshipment with label replacement or fast transshipment. The outgoing goods list unit 403 includes an address list 404 having a local delivery and an input field of destination. The buyer 200 can fill in the input field, so that the shipping party can have a clear address.

Finally, when the buyer 200 has doubts about the products and intent to return the products, the buyer 200 can also enter the return information in the logistics warehouse operating system. The system further includes a return module 50 for receiving the purchase order 103 and work order 201 and generating a return list 501. The return list 501 shows a return type unit 502 and a return list unit 503, the return type unit shows 502 a return type and the return list unit 503 shows information about the goods. The return type unit 503 further generates a return type list 504 having input field of other return, order return, and amazon return. The buyer 200 can process product return at any time after the purchase order 103 is formed, before or after the products are ready for incoming into the warehouse, and before or after the products are ready to be shipped out, so that the products can be effectively followed up and processed, and the loss and waste of the goods can be prevented.

Further, the buyer 200 can also choose the return method. The return list unit 503 includes a return method list 505 having input fields of a courier number and an operation type, and the operation type includes a process list 506 having input fields of inventory, outgoing, destruction, and the input field of the outgoing includes a delivery method and a destination. Accordingly, additional circulation of the products can be prevented, and the privacy of the buyer 200 and the seller 300 can be protected.

1. A logistics warehouse operating system, applied to a buyer and set up in a server, the system comprising:
an order placing module, including a basic information unit and an inquiry unit; wherein the buyer fills in the recipient's information, address, and products in the basic information unit; the inquiry unit includes a fee list showing the fee according to different destinations; wherein the order placing module further generates a purchase order;
a work order module, connected with the order placing module, the purchase order is transmitted to the work order module, and the work order module generates a work order by the information of the purchase order and the information that the buyer filled; wherein the work order includes a work order type unit, a work order level unit and a business selecting unit; wherein the work order type unit lists the operation mode for the goods, the work order level unit lists the processing time of the goods, and the business selecting unit lists the number of the goods to be processed for the buyer to select;
an incoming stock module, receiving the purchase order and work order and generating an incoming stock list; wherein the incoming stock list includes an incoming stock information unit and an incoming goods list unit, the incoming stock information unit shows incoming stock information, and the incoming goods list unit is used for the buyer to fill in the processing method after incoming stock information is completed; and
an outgoing stock module, receiving the purchase order and work order and generating an outgoing stock list; wherein the outgoing stock list includes a shipment information unit and an outgoing goods list unit, the shipment information unit is used to choose the shipment type, and the outgoing goods list unit is used to choose the shipment way.

2. The logistics warehouse operating system according to claim 1, further including a return module, receiving the purchase order and work order and generating a return list; wherein the return list includes a return type unit and a return list unit, the return type unit shows a return type and the return list unit shows information of the goods.

3. The logistics warehouse operating system according to claim 1, wherein the work order type unit includes a type information input for inputting or displaying general data, photo data, inventory data, tally data, pallet data, and labeling data.

4. The logistics warehouse operating system according to claim 1, wherein the work order level unit includes a level list for choosing a common option or an urgent option.

5. The logistics warehouse operating system according to claim 1, wherein the incoming stock information unit includes an incoming stock information list including incoming stock type, shipping method, delivery method, shipping date, estimated arrival time, remarks, and input messages.

6. The logistics warehouse operating system according to claim 1, wherein after the incoming goods list unit generates the incoming stock list, an incoming processing list is further generated, and the incoming processing list includes input fields for inventory, transshipment with label replacement, and fast transshipment.

7. The logistics warehouse operating system according to claim 1, wherein the shipment information unit includes a shipment processing list having input fields for transshipment with label replacement, and fast transshipment.

8. The logistics warehouse operating system according to claim 1, wherein the outgoing goods list unit includes an address list having a local delivery and an input field of destination.

9. The logistics warehouse operating system according to claim 2, wherein return type unit includes a return type list having input fields of other return, order return and amazon return.

10. The logistics warehouse operating system according to claim 2, wherein the return list unit includes a return method list having input fields of a courier number and an operation type, and the operation type includes a process list having input field of inventory, outgoing, destruction, and the input field of the outgoing includes a delivery method and a destination.
